(19) United States
(12) Patent Application Publication
(10) Pub. No.: US 2023/0216681 A1
(43) Pub. Date: Jul. 6, 2023

(54) API USER TRACKING VIA TOKEN TO API KEY MAPPING

(71) Applicant: Imperva, Inc., San Mateo, CA (US)

(72) Inventors: Jonathan Roy Azaria, Beit Gamliel (IL); Tzlelponit Itzhak, Tel Aviv (IL); Matan Lion, Tel Aviv (IL)

(21) Appl. No.: 18/074,384

(22) Filed: Dec. 2, 2022

Related U.S. Application Data
(60) Provisional application No. 63/295,787, filed on Dec. 31, 2021.

(51) Int. Cl. H04L 9/32; H04L 67/02

(52) U.S. Cl. CPC H04L 9/3213; H04L 67/02

(57) ABSTRACT

Embodiments of the present disclosure relate to tracking a user’s activity using a mapping of their API key to a token. A proxy device may receive a registration request from a client, the registration request including a first API key. The proxy device may forward the registration request to a registration endpoint and receive a first token generated using the first API key during an authentication process performed by the registration endpoint. The proxy device may associate the first API key with the first token and forward the first token to the client. The proxy device may receive a service request from the client that includes the first token and may add information regarding the service request into an entry in a log corresponding to the first API key.

### CROSS-REFERENCE TO RELATED APPLICATIONS

This application claims priority to U.S. Provisional Application No. 63/295,787 filed on Dec. 31, 2021 and entitled “API USER TRACKING VIA TOKEN TO API KEY MAPPING,” the disclosure of which is hereby incorporated in its entirety.

### BACKGROUND

An application programming interface (API) is a connection between computer programs. It is a type of software interface, offering a service to other software. For example, an API can be used to transmit information back and forth between a website or app and a user.

An API key is a unique identifier that is used to authenticate a user to an API. API keys are generally not considered secure; they are typically accessible to clients, making it easy for someone to steal an API key. Once the key is stolen, it may have no expiration, so it may be used indefinitely.

For security reasons, many API infrastructures don’t use API keys for authorization purposes. Instead, they require users to first login at a specific registration endpoint with their API key in order to receive a “short-lived token,” which as its name suggests is a token with an expiration date.

A token is typically formed of three key components: a header, payload, and signature. The header may define the token type being used, as well as a signing algorithm involved. The payload is usually responsible for defining the token issuer and the token’s expiration details. It may also provide information about the user plus other metadata. The signature can verify the authenticity of a message such as a request for API service, and that the message has not changed while in transit.

Short-lived tokens allow users to access APIs without having to enter their login credentials each time they visit. Instead, the user logs in once, and a unique token is generated and shared. Users of tokens are provided with access to API services until they log out or close the services. If an attacker manages to acquire a short-lived token, it won’t be useful for long because it will eventually expire, limiting the possible impact.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example information processing system, in accordance with one embodiment of the present disclosure.

FIG. 2 is a flowchart illustrating relevant aspects of a process implemented by the information processing system of FIG. 1.

FIG. 3 is a flowchart illustrating relevant aspects of another process implemented by the information processing system of FIG. 1.

FIG. 4 is a block diagram that illustrates an example information processing system, in accordance with another embodiment of the present disclosure.

FIG. 5 is a flowchart illustrating relevant aspects of a process implemented by the information processing system of FIG. 4.

FIG. 6 is a flowchart illustrating relevant aspects of another process implemented by the information processing system of FIG. 4.

FIG. 7 is a flowchart illustrating relevant aspects of an example threat detection algorithm implemented by the information processing system of FIG. 1 or FIG. 4.

FIG. 8 is a block diagram of an example computing device that may perform one or more of the operations described herein, in accordance with some embodiments of the present disclosure.

### DETAILED DESCRIPTION

Token authorization works through a multi-step process. For example, a user can send a request to a registration endpoint executing on a computing device (e.g., a server). The request may include an API key. The registration endpoint may then verify the user using the API key in order to determine that the user should have access to API services. The registration endpoint generates a secure, signed short-lived token using a signing algorithm. A specific period of time is set for short-lived tokens. The short-lived token is transmitted back to the user’s computing device, which stores it for enabling future access. The short-lived token will remain active until the user logs out or it expires.

There are numerous issues involved with authorization of users seeking to access application program interfaces (APIs) using short-lived tokens. A primary issue is that short-lived tokens may not reveal the API key that was used to generate it, making it difficult to monitor users or log the services they request over time. Accordingly, it may be difficult to track a user’s behavior for a period of time that’s longer than the short-lived token’s expiration. Also, a user’s behavior pattern may be very difficult to identify when short-lived tokens constantly shift. And if attackers manage to get the API key itself, they can create a multitude of short-lived tokens, making it much more difficult to identify an attack and block it.

The present disclosure provides a proxy that is in data communication between a client computing device (hereinafter client) on one side and a registration endpoint and API services on the other side. The proxy receives registration requests and API service requests from clients. Before a registration request is forwarded to the registration endpoint, the proxy can read and store the registration request’s API key. The registration request is subsequently forwarded to the registration endpoint where the API key is used to generate a short-lived token. The token is provided back to the proxy in a message from the endpoint registration. The proxy can use the short-lived token to monitor the user and/or log services subsequently requested by the user.

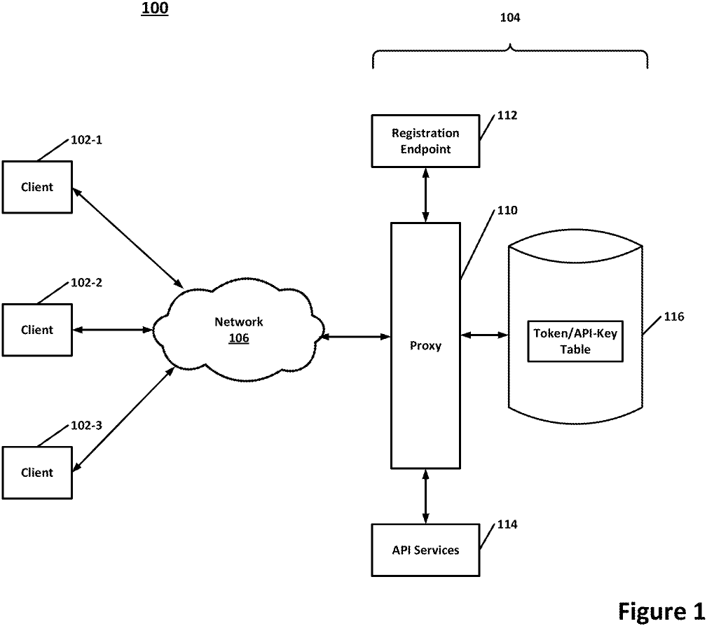

FIG. 1 is a block diagram illustrating relevant components of a communication system 100 employing one embodiment of the present disclosure. As shown communication system 100 includes a plurality of client computing devices 102 in data communication with an information system 104 (e.g., a website) via a communication network 106.

Network 106 may be a public network (e.g., the internet), a private network (e.g., a local area network (LAN) or wide area network (WAN)), or a combination thereof. In one embodiment, network 106 may include a wired or a wireless infrastructure, which may be provided by one or more wireless communications systems, such as a Wi-Fi® hotspot connected with the network 106 and/or a wireless carrier system that can be implemented using various data processing equipment, communication towers (e.g. cell towers), etc. The network 106 may carry communications (e.g., data, message, packets, frames, etc.) between a client 102 and information system 104. Clients 102 and information system 104 may each include hardware such as processing device (e.g., processors, central processing units (CPUs)), memory (e.g., random access memory (RAM), storage devices (e.g., hard-disk drive (HDD)), and solid-state drives (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

FIG. 1 and the other figures may use like reference numerals to identify like elements. A hyphened number after a reference numeral, such as “102-1,” indicates that the text refers specifically to the element having that particular reference numeral. A reference numeral in the text without a following hyphened number, such as “102,” refers to any or all of the elements in the figures bearing that reference numeral.

Clients 102 and information system 104 may each include any suitable type of computing device or machine that has a programmable processor including, for example, server computers, desktop computers, laptop computers, tablet computers, smartphones, set-top boxes, etc. In some examples, clients 102 and information system 104 may each comprise a single computing device or may include multiple interconnected computing devices (e.g., multiple servers configured in a cluster). Clients 102 and information system 104 may be implemented by a common entity/organization or may be implemented by different entities/organizations. For example, client 102-1 may be operated by a first entity and information system 104 may be operated by a second entity. Clients 102 and information system 104 may each execute or include an operating system (OS) (not shown in the figures). The OSs of clients 102 and information system 104 may manage the execution of other components (e.g., software, applications, etc.) and/or may manage access to the hardware (e.g., processors, memory, storage devices etc.) of the computing device.

Clients 102 may run an application (e.g., a browser) which may allow a user to interact with information system 104. When users want to access information system 104, they may utilize the application to connect to information system 104, and make calls to the information system 104. The information system 104 may further include any appropriate type of storage system such as an object storage system, a database, a filesystem, or a cloud storage layer, for example.

Returning to FIG. 1 information system 104 includes a proxy 110, a registration endpoint 112, and API services 114, each of which may take form in instructions executing on one or more computing devices (e.g. servers). Proxy 110, registration endpoint 112, and API services 114 are in data communication with each other. Endpoint registration 112 may be responsible for login and authentication of users. Endpoint registration 112 can be configured to generate short-lived tokens based upon API keys that are received in registration requests from clients 102 via proxy 110. API services 114 are capable of providing services upon request to any of clients 102. Proxy 110 is in data communication with clients 102 via network 106, while endpoint registration 112 and API services 114 are in data communication with clients 102 via proxy 110 and network 106. Information system 100 also includes a storage system 16 in data communication with node 110. Storage 116 can store a table or other data object that maps API keys to respective short-lived tokens as will be more fully described below.

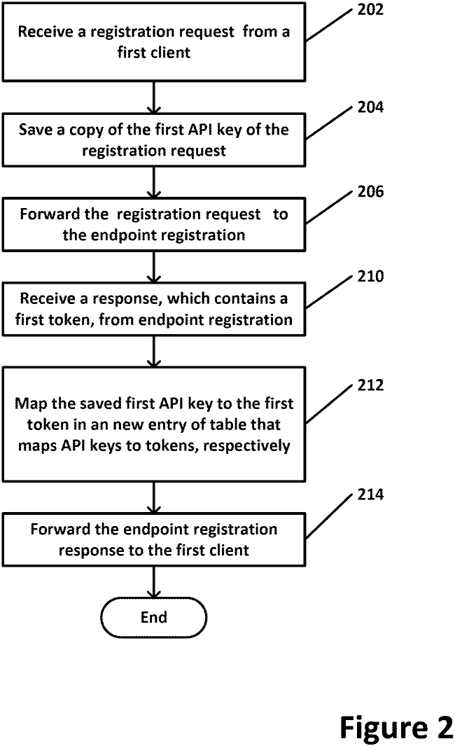

FIG. 2 is a flow chart illustrating relevant aspects of a method performed by proxy 110 according to one embodiment of the present disclosure. The method shown in FIG. 2 starts when proxy 110 receives a registration request from a client such as client 102-1. The request for registration should include a first API key. In response to receiving the request, proxy 110 saves a copy of the first API key in step 204. The copy can be saved in memory that is local to proxy 110. Thereafter, in step 206, the proxy 110 forwards the registration request to endpoint registration 112, which in turn may perform an authentication process using the first API key of the request. Presuming successful authentication, endpoint registration 112 uses the first API key to generate a first short-lived token for use in subsequent API service requests. Endpoint registration 112 generates a response to the registration request. This response includes the generated first short-lived token. Endpoint registration 112 sends the generated response to proxy 110. In response to receiving the response from endpoint registration 112, proxy 110 creates a new entry in the table of storage 116. In step 212, proxy 110 maps the first API key to the first short-lived token in the newly created table entry. Thereafter, proxy 110 forwards the first endpoint registration response to the first client as shown in step 214.

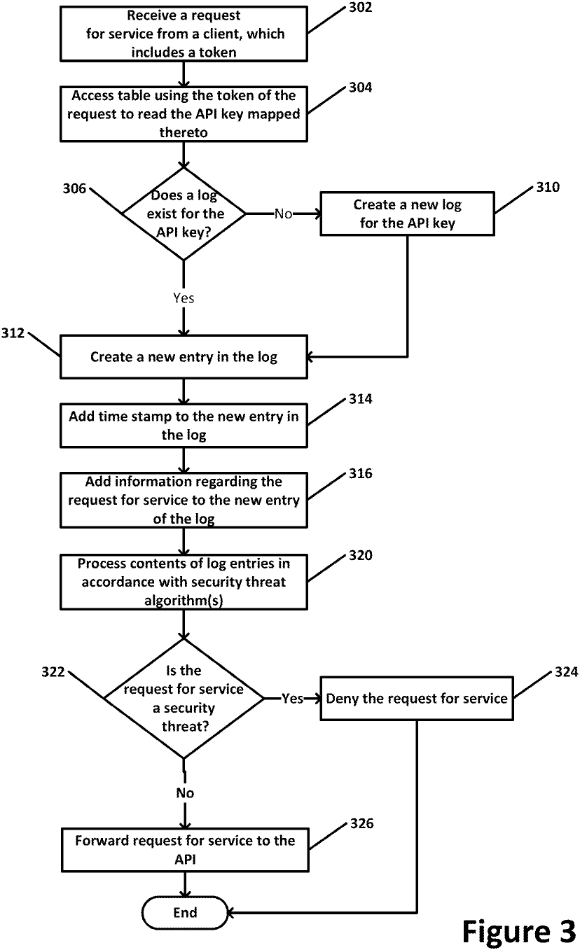

The table of mapped short-lived tokens and API keys held in storage 116, can be used in a method to monitor API users. This monitoring can be used for various purposes including, for example, prevention of malicious activity. FIG. 3 illustrates a flowchart that describes relevant aspects of a method implemented by proxy 110 for monitoring users. The process is implemented in response to each API service request received by proxy 110 from a client system 102. In step 302, the proxy receives a request for service from a client, which includes a short-lived token. Proxy 110 uses the short-lived token to access the table in database 116 and read a corresponding API key mapped therein as shown in step 304. Proxy 110 accesses memory to determine whether a log exists for the API key that was read in step 304. If no log exists, then proxy 110 creates one in memory as shown in step 310. If a log preexists in memory or in response to creating a new log, the process proceeds to step 312 where proxy creates a new entry in the log. Proxy 110 adds a time stamp into a field of the new entry in the log as shown in step 314. The time stamps in the log can be used for determining whether excessive API service requests are being received. In step 316 proxy 110 may add information regarding the request for service into one or more additional fields of the newly created entry. The information regarding the request for service may comprise information that can be used to detect malicious activity. For example, the information regarding the request for service may include the country of origin of the client requesting access to the service. In another example, the information regarding the request for service may include parameter values that are unique to the client (e.g., bank account ID). The proxy 110 may also store information regarding the history of requests (i.e., all of the requests) associated with the same API key, such as e.g., the total number of requests made, the total number of requests made during a particular time period (e.g., the total number of requests made in a week, or on a Tuesday), and the nature/type of requests made by a client associated with the API key. Such historical request information may be an indicator of anomalies both with respect to the API key itself (its logs) and with respect to comparison with other API keys.

Thereafter, proxy 110 processes the contents of the log in accordance with one or more security threat algorithms as shown in step 320. For example, after analyzing the contents of the log with the one or more security threat algorithms, the proxy 110 may determine that the country of origin of the request has changed too many times (e.g., more than a threshold number of times) throughout the different log entries, which may be a sign that certain requests are a security threat. Further, if the parameter values included in the request change throughout the different log entries, this may also be a sign that certain requests are a security threat. In addition, the one or more security algorithms may analyze historical request information associated with the same API key. For example, the total amount of requests for each API key may be saved by the proxy 110. In this way, an unusually large number of requests made by a particular API key within a certain time frame (determined based on the time stamps associated with the requests), which may be a sign of malicious activity, can be detected.

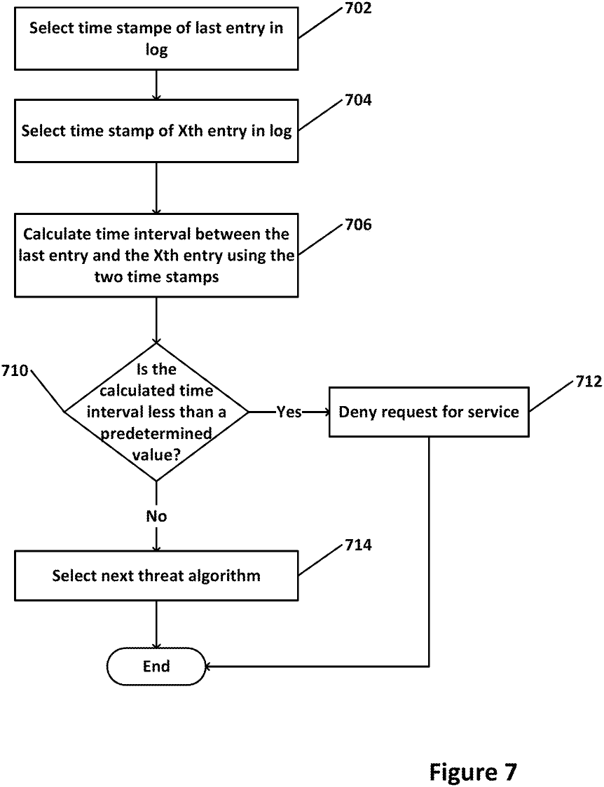

As will be more fully described below, FIG. 7 illustrates an example of a security threat algorithm that could be implemented in step 320 by proxy 110. In response to processing contents of the log entries, proxy 110 can determine whether the request received in step 302 is a security threat as shown in step 322. If a threat is determined in step 322, the request received in 302 is denied as shown in step 324. Otherwise, as shown in step 326 the request for service is forwarded by proxy 110 to API services 114.

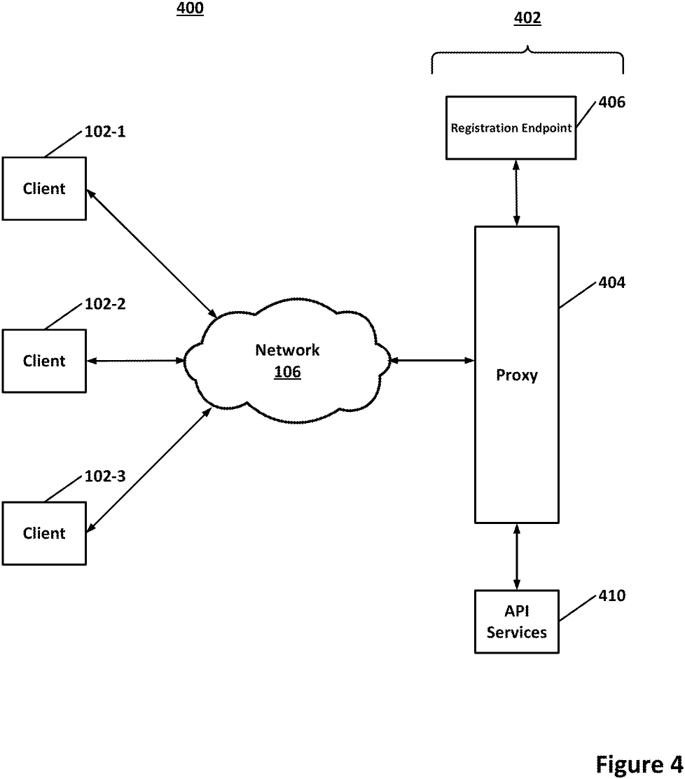

FIG. 4 illustrates an alternative embodiment of a system 400 implementing another embodiment of the present disclosure. System 400 includes an information processing system 402 in data communication with clients 102 via network 106. Information system 402 includes a proxy 404, a registration endpoint 406, and API services 410 that are executing on one or more computing devices (e.g. servers). Proxy 404, registration endpoint 406, and API services 410 are in data communication with each other. Endpoint registration 406 is configured to generate short-lived tokens based upon API keys that are received in registration requests from clients 102 via proxy 404. API services 410 are capable of providing services upon request to any of the client computer systems 102. Proxy 404 is in data communication with clients 102 via network 106, while endpoint registration 406 and API services 410 are in data communication with clients 102 via proxy 404 and network 106. Information system 402 lacks storage or memory for storing the table mentioned above for mapping API keys to short-lived tokens.

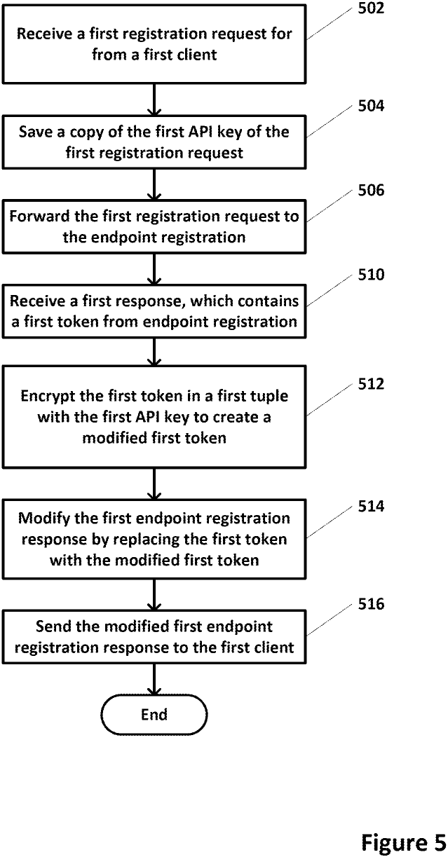

FIG. 5 is a flowchart illustrating relevant aspects of a method implemented by proxy 404. Like the process shown in FIG. 2, the process shown in FIG. 5 enables proxy 404 to create logs that can be used for monitoring respective users of API services 410. The process in FIG. 5 starts when proxy 404 receives a registration request from a first client such as client 102-1. The request includes a first API key. In response, proxy 404 saves a copy of the first API key in step 504. Thereafter, proxy 440 forwards the registration request to endpoint registration node 406, which in turn may perform authentication process using the first API key of the request. Presuming successful authentication, endpoint registration 406 uses the first API key to generate a first short-lived token for use in subsequent API service requests. Endpoint registration 406 generates a response to the first registration request. This response includes the generated first short-lived token. Endpoint registration 406 sends the generated response to proxy 404 in a first registration response message. In response to receiving the first registration response message from endpoint registration 406, proxy 404 encrypts the first short-lived token in a first tuple with the first API key that was received in step 502, to create a modified first token as shown in step 512. Proxy 404 modifies the first endpoint registration response provided by endpoint registration node 406, by replacing the first short-lived token with the modified first token as shown in step 514. Thereafter, proxy 404 forwards the modified first endpoint registration response to the first client. The process ends.

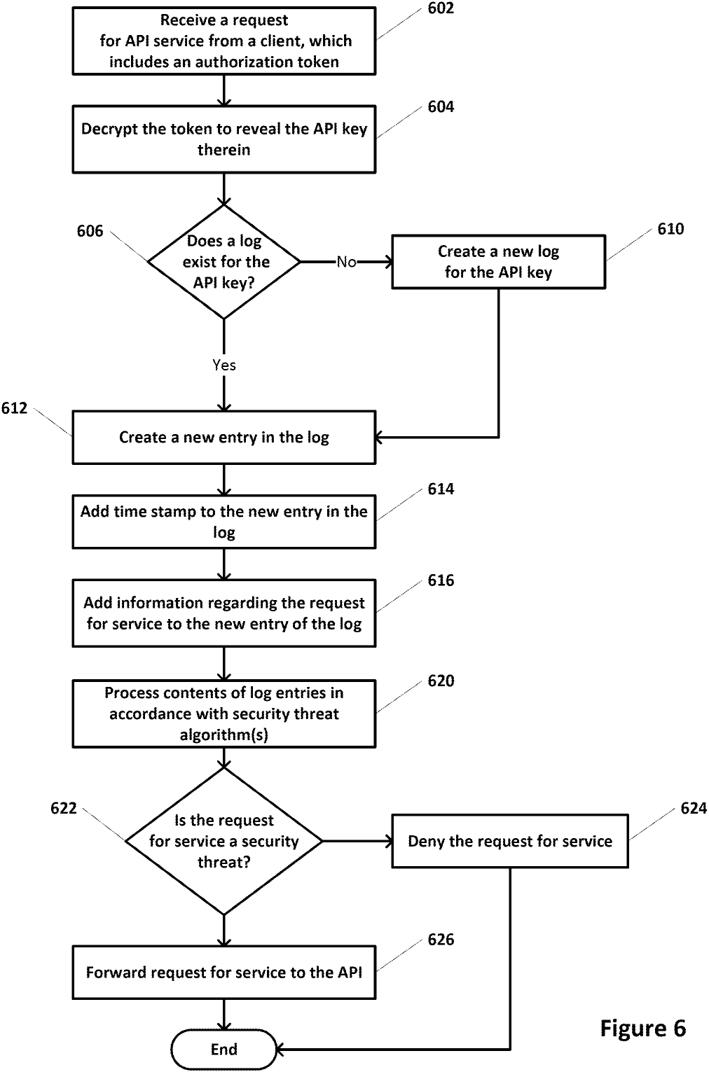

Proxy 404 can use the tokens it generates to monitor users of API services provided by nodes 410. FIG. 6 is a flow chart illustrating relevant aspects implemented by proxy 404 for monitoring client request for API services. The method starts in step 602 when proxy 404 receives a request for service from a client, such as client 102-1, which includes a token. In step 604 proxy 404 decrypts the token received in step 602 to reveal the API key contained therein. In step 606 proxy 404 accesses memory to determine whether a log exists for the API key revealed in step 604. In response to finding a log in memory or in response to creating a new log in memory for the API key, proxy 404 creates a new entry in the log as shown in step 612. A time stamp is added to a field within the newly created entry in the log, and as shown in step 616 proxy 404 adds additional information regarding the request for service to one or more fields of the newly created entry of the log associated with the API key.

The information regarding the request for service may comprise information that can be used to detect malicious activity. For example, the information regarding the request for service may include the country of origin of the client requesting access to the service. In another example, the information regarding the request for service may include parameter values that are unique to the client (e.g., bank account ID). The proxy 110 may also store information regarding the history of requests (i.e., all of the requests) associated with the same API key, such as e.g., the total number of requests made, the total number of requests made during a particular time period (e.g., the total number of requests made in a week, or on a Tuesday), and the nature/type of requests made by a client associated with the API key. Such historical request information may be an indicator of anomalies both with respect to the API key itself (its logs) and with respect to comparison with other API keys.

Thereafter, in step 620 proxy 404 processes the contents of the log entries in accordance with one or more security threat algorithms. For example, after analyzing the contents of the log with the one or more security threat algorithms, the proxy 110 may determine that country of origin of the request has changed too many times (e.g., more than a threshold number of times) throughout the different log entries, which may be a sign that certain requests are a security threat. Further, if the parameter values included in the request change throughout the different log entries, this may also be a sign that certain requests are a security threat. In addition, the one or more security algorithms may analyze historical request information associated with the same API key. For example, the total amount of requests for each API key may be saved by the proxy 110. In this way, an unusually large number of requests made by a particular API key within a certain time frame (determined based on the time stamps associated with the requests), which may be a sign of malicious activity, can be detected. If proxy 404 determines the request received in step 602 is a security threat, the request for service is denied as shown in step 624. Otherwise, proxy forwards the request to the API services 410.

As noted in the flowcharts of FIGS. 3 and 6, proxy 110 or proxy 404 processes contents of log entries in accordance with one or more security threat algorithms. FIG. 7 is an example of one security threat algorithm that can be implemented by proxy 110 or proxy 404. This process can be implemented each time proxy 404 or 110 receives a request for API service from a client 102. In step 702 the time stamp of the last entry created in the log is selected. Then in step 704 the time stamp of the Xth entry in the log is selected, where X is a predetermined number. At step 706, a time interval between the last entry and the Xth entry is calculated based on the time stamps of the two entries. The proxy then determines whether the calculated time interval is less than the predetermined value in step 710. If it is, the request for service is denied in 712. Otherwise, the request for API service is forwarded to API services 114 or 410, or the next threat algorithm 714 is selected and implemented as shown in step 714.

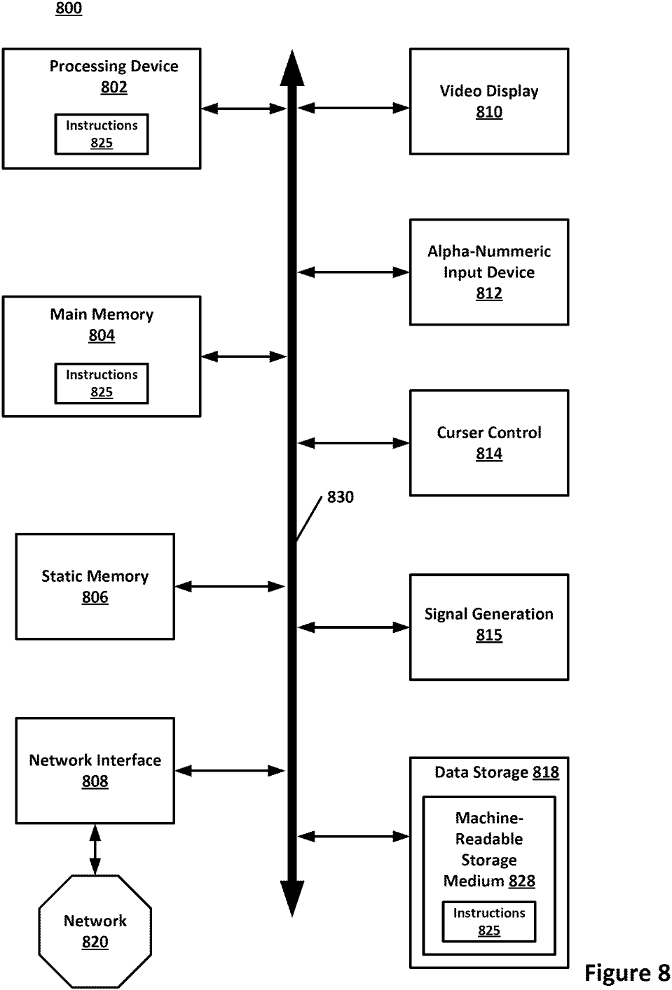

FIG. 8 is a block diagram of a computing device 800 within which a set of instructions, for causing the computing device to perform any one or more of the methods discussed herein.

Computing device 800 may be connected (e.g., networked) to other computing devices in a local area network (LAN), an intranet, an extranet, or the Internet. The computing device may operate in the capacity of a server or a client in a client-server network environment, or as a peer machine in a peer-to-peer (or distributed) network environment. The computing device may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single computing device is illustrated, the term “computing device” shall also be taken to include any collection of machines that individually or jointly execute a set (or multiple sets) of instructions to perform any one or more of the methods discussed herein. In one embodiment, computing device 800 may be representative of a server.

The example computer system 800 includes a processing device 802, a main memory 804 (e.g., read-only memory (ROM), flash memory, dynamic random access memory (DRAM), a static memory 806 (e.g., flash memory, static random access memory (SRAM), etc.), and a data storage device 818, which communicate with each other via a bus 830. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 800 may further include a network interface device 808 which may communicate with a network 820. The computing device 800 also may include a video display unit 810 (e.g., a liquid crystal display (LCD) or a cathode ray tube (CRT)), an alphanumeric input device 812 (e.g., a keyboard), and a cursor control device 814 (e.g., a mouse). In one embodiment, video display unit 810, alphanumeric input device 812, and cursor control device 814 may be combined into a single component or device (e.g., an LCD touch screen).

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute instructions 825, for performing the operations and steps discussed herein.

The data storage device 815 may include a machine-readable storage medium 828, on which is stored one or more sets instructions 825 (e.g., software) embodying any one or more of the methods described herein. The instructions 825 may also reside, completely or at least partially, within the main memory 804 or within the processing device 802 during execution thereof by the computer device 800; the main memory 804 and the processing device 802 also constituting machine-readable storage media. The instructions 825 may further be transmitted or received over a network 820 via the network interface device 808.

The machine-readable storage medium 828 may also be used to store instructions to perform a method as described herein. While the machine-readable storage medium 828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magnetooptical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A method comprising:
receiving, at a proxy device, a registration request from a client, the registration request including a first API key;
forwarding the registration request to a registration endpoint to perform an authentication process;
receiving a first token generated using the first API key during the authentication process;
associating the first API key with the first token;
forwarding the first token to the client;
receiving a service request from the client, the service request including the first token; and
adding information regarding the service request into an entry in a log corresponding to the first API key.

2. The method of claim 1, further comprising:
processing the contents of the entry in accordance with one or more security threat algorithms to determine if the service request is a security threat.

3. The method of claim 1, wherein associating the first API key with the first token comprises:
creating a new entry in a table associated with the proxy device; and
mapping the first API key to the first token in the new entry.

4. The method of claim 3, further comprising:
in response to receiving the service request from the client, using the table to identify the first API key as corresponding to the first token;
determining whether the log corresponding to the first API key exists; and
in response to determining that the log corresponding to the first API key does not exist, generating the log corresponding to the first API key.

5. The method of claim 1, wherein associating the first API key with the first token comprises:
encrypting the first API key inside the first token.

6. The method of claim 5, further comprising:
in response to receiving the service request from the client, decrypting the first token to identify the first API key as corresponding to the first token.

7. The method of claim 2, further comprising:
adding time stamp data into the entry corresponding to the first API key, wherein the one or more security threat algorithms process the time stamp data to determine whether excessive API service requests are being received.

8. A system comprising:
a memory; and
a processing device, operatively coupled to the memory, the processing device to:
receive, at a proxy device, a registration request from a client, the registration request including a first API key;
forward the registration request to a registration endpoint to perform an authentication process;
receive a first token generated using the first API key during the authentication process;
associate the first API key with the first token;
forward the first token to the client;
receive a service request from the client, the service request including the first token; and
add information regarding the service request into an entry in a log corresponding to the first API key.

9. The system of claim 8, wherein the processing device is further to:
process the contents of the entry in accordance with one or more security threat algorithms to determine if the service request is a security threat.

10. The system of claim 8, wherein to associate the first API key with the first token, the processing device is to:
create a new entry in a table associated with the proxy device; and
map the first API key to the first token in the new entry.

11. The system of claim 10, wherein the processing device is further to:
in response to receiving the service request from the client, use the table to identify the first API key as corresponding to the first token;
determine whether the log corresponding to the first API key exists; and
in response to determining that the log corresponding to the first API key does not exist, generate the log corresponding to the first API key.

12. The system of claim 8, wherein to associate the first API key with the first token, the processing device is to:
encrypt the first API key inside the first token.

13. The system of claim 12, wherein the processing device is further to:
in response to receiving the service request from the client, decrypt the first token to identify the first API key as corresponding to the first token.

14. The system of claim 9, wherein the processing device is further to:
add time stamp data into the entry corresponding to the first API key, wherein the one or more security threat algorithms process the time stamp data to determine whether excessive API service requests are being received.

15. A non-transitory computer-readable medium having instructions stored thereon which, when executed by a processing device, cause the processing device to:
receive, at a proxy device, a registration request from a client, the registration request including a first API key;
forward the registration request to a registration endpoint to perform an authentication process;
receive a first token generated using the first API key during the authentication process;
associate the first API key with the first token;
forward the first token to the client;
receive a service request from the client, the service request including the first token; and
add information regarding the service request into an entry in a log corresponding to the first API key.

16. The non-transitory computer-readable medium of claim 15, wherein the processing device is further to:
process the contents of the entry in accordance with one or more security threat algorithms to determine if the service request is a security threat.

17. The non-transitory computer-readable medium of claim 15, wherein to associate the first API key with the first token, the processing device is to:
create a new entry in a table associated with the proxy device; and
map the first API key to the first token in the new entry.

18. The non-transitory computer-readable medium of claim 17, wherein the processing device is further to:
in response to receiving the service request from the client, use the table to identify the first API key as corresponding to the first token;
determine whether the log corresponding to the first API key exists; and
in response to determining that the log corresponding to the first API key does not exist, generate the log corresponding to the first API key.

19. The non-transitory computer-readable medium of claim 15, wherein to associate the first API key with the first token, the processing device is to:
encrypt the first API key inside the first token.

20. The non-transitory computer-readable medium of claim 19, wherein the processing device is further to:
in response to receiving the service request from the client, decrypt the first token to identify the first API key as corresponding to the first token.
